(19) United States
(12) Patent Application Publication
(10) Pub. No.: US 2024/0416926 A1
(43) Pub. Date: Dec. 19, 2024

(54) METHOD FOR THE DYNAMIC ESTIMATION OF THE PITCH OF A MOTOR VEHICLE BY MEANS OF AN IMAGE CAPTURE SENSOR

(71) Applicant: Continental Autonomous Mobility Germany GmbH, Ingolstadt (DE)

(72) Inventors: Gatien FERRET, Toulouse (FR); Hugo CHOCHOY, Toulouse (FR); Matthieu BERGER, Toulouse (FR)

(73) Assignee: Continental Autonomous Mobility Germany GmbH, Ingolstadt (DE)

(21) Appl. No.: 18/708,337

(22) PCT Filed: Nov. 8, 2022
(86) PCT No.: PCT/EP2022/081153

§ 371 Date: May 8, 2024

(30) Foreign Application Priority Data
Nov. 9, 2021 (FR) 2111851

(51) Int. Cl. B60W 40/11; G06V 20/56

(52) U.S. Cl. CPC B60W 40/11; G06V 20/588

(57) ABSTRACT

A method for estimating the pitch of a motor vehicle by an image-acquiring sensor that is located on board the motor vehicle. The method includes at least a first estimating step consisting in estimating a first pitch angle of the sensor using a first estimating method that integrates a drift-avoidance coefficient aiming to limit drift of the estimation of the first pitch angle, a second estimating step that consists in estimating a second pitch angle of the sensor, using a second estimating method, and a fourth step that consists in refining said first pitch angle by increasing the drift-avoidance coefficient to obtain a refined first pitch angle considered as output angle, if at least one first condition is validated.

### CROSS REFERENCE TO RELATED APPLICATIONS

This application is the U.S. National Phase Application of PCT International Application No. PCT/EP2022/081153, filed Nov. 8, 2022, which claims priority to French Patent Application No. 2111851, filed Nov. 9, 2021, the contents of such applications being incorporated by reference herein.

### FIELD OF THE INVENTION

The present patent application relates to the field of advanced driver assistance systems employing an image-acquiring sensor of the video-camera type, and more particularly to optimization of the acquisition of information relating to the environment of a motor vehicle using a method for dynamically estimating pitch by means of an image-acquiring sensor that is mounted on the vehicle.

### BACKGROUND OF THE INVENTION

Advanced driver assistance systems (ADAS) are increasingly common in motor vehicles. They offer an increasing number of features with the aim of improving the comfort and safety of vehicle users. Ultimately, producing autonomous vehicles is conceivable.

Many of the functionalities offered by such systems rely on a real-time analysis of the immediate environment of the vehicle on board of which they are located. Whether it is a question, for example, of assisting with emergency braking or improving control of the path of an automobile, it is necessary, at all times, for characteristics of the environment of the vehicle to be taken into account to provide the functionalities of the advanced driver assistance system.

In this context, one possible way of acquiring information relating to the immediate environment of a motor vehicle is to use means for acquiring and analyzing images. A vehicle may thus be equipped with one or more video cameras intended to observe its environment, at all times, in one or more observation directions. The images collected by the cameras are then processed by the advanced driver assistance system and the latter may use them to potentially trigger a driver assistance action, for example generation of an audio and/or visual alert, or even braking or changing the path of the motor vehicle.

This type of operation assumes that the images collected by the one or more cameras allow the desired relevant information on the environment of the vehicle to be collected reliably, and with the lowest possible computational cost. This in particular requires the acquired images to actually be representative of observed reality and not to contain any artefacts liable to distort perception of the environment by the advanced driver assistance system. This also requires, for certain functionalities, that it be possible for the advanced driver assistance system, on the basis of the images acquired by the camera, to correctly locate the various objects present in the three-dimensional space through which the vehicle is moving.

This is the case, for example, in the conventional situation where the advanced driver assistance system employs the images acquired by a camera mounted on the front windscreen of a vehicle, near its central rear-view mirror. Specifically, for certain functionalities to be able to employ such images it is necessary to know the relationship between the spatial coordinates of a point in space and the corresponding point in the image acquired by the camera, which therefore presupposes knowledge of the spatial relationship between the camera and the vehicle. To ensure satisfactory knowledge of these relationships, it is known to carry out calibration of the camera relatively frequently. The purpose of this calibration is to determine parameters, called intrinsic parameters and extrinsic parameters, of the camera.

The intrinsic parameters are related to the specific technical characteristics of the camera, such as, for example, its focal length, the position of its optical center or its distortion model. Their calibration allows these parameters to be estimated and this is therefore done in the factory at the end of the production line of the camera.

The extrinsic parameters correspond, for their part, to the position and orientation of the camera with respect to an assumed world frame, which is subject to potential tilt of the vehicle with respect to the road over which the vehicle is being driven, parallel to said road. These parameters comprise the three translations and the three rotations required to pass from the coordinates of a point expressed in the frame defined above (called the “world frame”) to the coordinates of this point expressed in a frame linked to the camera (called the “camera frame”). Calibration of these parameters (six in total) then allows the position and the orientation of the camera with respect to the road to be estimated. In addition, since these parameters change more frequently than the intrinsic parameters, for example in the event of a change in vehicle load, the extrinsic parameters may be calibrated relatively frequently in order to constantly adjust their values to the situation encountered.

The notion of “calibration” often applies to a variable that oscillates little and that defines an absolute angle between the camera and the world frame. It is an average, or a nominal value, that does not take into account oscillations of the camera.

The calibration at the end of the production line of the vehicle, which uses a production test pattern, and the so-called “on-line” calibration, which is based on the video stream delivered by the camera, are not the same.

Finally, the objective of the calibration of the camera is to facilitate exploitation of the images acquired by the camera, in order to improve localization in space of the various observed objects.

Nonetheless, regardless of the frequency with which it is carried out, calibration does not allow dynamic pitch and roll, which cause substantial dynamic changes to the orientation of the camera, to be followed.

By pitch of the camera, what is meant is an angular movement of the camera about a transverse axis perpendicular to the longitudinal path of the motor vehicle, and by roll what is meant is an angular movement of the camera about a longitudinal axis parallel to the longitudinal path of the motor vehicle, their values being estimated using the video stream delivered by the camera.

The notion of dynamic pitch and roll regards the same physical quantity as the calibration, i.e. the angle of the camera with respect to a frame, generally the “world” frame.

However, dynamic pitch and roll are not averages or nominal values but instantaneous values that oscillate about the calibration values.

Typically, in situations such as crossing a humpback bridge, a substantial acceleration or deceleration, or a sudden change in slope, the value of the dynamic, or instantaneous, pitch may temporarily deviate, significantly, from its calibrated value. Likewise, when the vehicle is driven over a speed cushion or pothole in an “asymmetrical” manner, or in other words when only the wheels on one side of the vehicle pass over the speed cushion or the pothole, or in the case of a sharp bend, the dynamic, or instantaneous, roll value may temporarily deviate, significantly, from its calibrated value.

However, whether the angle corresponding to pitch and the angle corresponding to roll are known satisfactorily has a decisive impact on localization in space of the objects observed by the camera of a motor vehicle. Therefore, poor evaluation thereof, albeit temporarily, is liable to affect correct determination of the position of the objects surrounding the vehicle, and therefore to limit or even block certain ADAS functionalities based thereon.

In order to estimate the dynamic pitch, which will be referred to simply as pitch below, and the dynamic roll, which will be referred to simply as roll below, of a camera located on board a vehicle dynamically, i.e. in order to gauge rapid variations related to occasional changes in driving environment, it is already known to use the SLAM method (SLAM standing for Simultaneous Localization And Mapping).

This method consists, firstly, in simultaneously constructing the map of a place and locating the vehicle therein. It may moreover allow the pitch and the roll of the camera to be estimated, in particular by tracking, in the image, certain noteworthy objects and their movement from one image to another. However, it is very much subject to detection noise and is relatively limited in terms of the reactivity with which the pitch value and the roll value can actually be updated, when it is a question of obtaining a robust estimation.

Moreover, another known method consists in processing the images acquired by the on-board camera of a vehicle in order to recognize therein, in each image, the position of the line markings of the road over which the vehicle is being driven, and, to deduce therefrom, in real time, a pitch angle of the camera. This method allows the pitch to be estimated dynamically but presupposes the vehicle to be being driven over a road having parallel and recognizable line markings.

In addition, in the case of the two aforementioned methods, the estimation of the pitch value and of the roll value is only satisfactory in cases where they remain sufficiently close to expected values. In other words, as soon as the amplitude of the variation in pitch becomes very great, as is for example the case when crossing a humpback bridge or when accelerating sharply, or as soon as the amplitude of the variation in roll becomes very great, as is for example the case when crossing a speed cushion or a pothole, the two aforementioned methods may not be able to follow the changes in camera angle.

In order to overcome the drawbacks of the two methods mentioned, a method for dynamically estimating the pitch and the roll of a motor vehicle is known, this method being described and illustrated in document EP3579191B1, incorporated herein by reference.

The method described in document EP3579191B1 comprises a first step of computing an extrinsic tilt angle of a camera, which angle is estimated by integrating the relative movement of the camera at a current time t, and a second step of estimating an extrinsic tilt angle of the camera with drift correction.

By “tilt angle” or “angle of tilt” what is meant is a pitch angle but also a roll angle, i.e. the angle between the camera frame and a frame that is generally the world frame.

The first computing step determines the tilt angle using the following equation:
θᵢₙₜ(t)=θ(t−1)−θᵣₑₗ(t) with θ(t−1) the absolute extrinsic tilt angle of the camera at a previous time t−1, and θᵣₑₗ(t) the relative angle of the camera at the current time t, which expresses the angle of tilt of the sensor between said previous time t−1 and the current time t.

The second step estimates the tilt angle of the camera using the following equation:
θ(t)=θᵢₙₜ(t)+DAC(t)*(θ_{calib}(t)−θᵢₙₜ(t)) with θ(t) the absolute extrinsic tilt angle of the camera, at the current time t, θᵢₙₜ(t) the extrinsic tilt angle of the camera estimated by integrating the relative movement of the camera at a current time t in the course of the preceding first computing step, at the current time t, DAC(t) a drift-avoidance coefficient comprised between zero and one, at the current time t, and θ_{calib}(t) the calibration extrinsic tilt angle at the current time t, which is known at all times and which corresponds to the nominal value of the tilt angle of the camera when the motor vehicle is not moving.

The drift-avoidance coefficient is also known as the DAC for short.

Advantageously, the method described in document EP3579191B1 takes into account the movement of the camera and the multiplicity of driving scenarios that may be encountered, while avoiding drift through use of the drift-avoidance coefficient.

However, the method described in document EP3579191B1 is not satisfactory enough when the slope of the road changes, and in particular when the vehicle equipped with the camera and the object being tracked are located on lengths of road of different slope, for example when the object being tracked is located on an uphill slope while the vehicle is located at the bottom of this slope.

Specifically, the estimation of the tilt angle according to the method described in document EP3579191B1 is based on an integration of the relative movement of the camera, and hence the change in slope is not taken into account.

In contrast, the method described above, which is based on the recognition of line markings, performs better when it is a question of estimating the pitch angle of the camera in the event of a change in slope.

### SUMMARY OF THE INVENTION

An aspect of the present invention is in particular to solve the drawbacks of the aforementioned prior art by improving the method described in document EP3579191B1, through use of the pitch estimation of the method based on line-marking recognition.

This aspect as well as others that will become apparent on reading the following description are achieved with a method for estimating the pitch of a motor vehicle by means of at least one image-acquiring sensor that is located on board said motor vehicle and that is able to deliver images of the road over which the motor vehicle is moving, characterized in that it comprises at least:
a first estimating step consisting in estimating a first pitch angle θ₁(t) of the sensor using a first estimating method that integrates a drift-avoidance coefficient DAC(t) aiming to limit drift of the estimation of the first pitch angle θ₁(t),
a second estimating step that consists in estimating a second pitch angle θ₂(t) of the sensor, using a second estimating method,
a comparing third step consisting in examining at least a first condition that is validated if the absolute difference between the first pitch angle θ₁(t) and the second pitch angle θ₂(t) is greater than or equal to a first predefined threshold,
a fourth step that is executed if the first condition is validated and that consists in refining said first pitch angle θ₁(t) by increasing the drift-avoidance coefficient DAC(t) to obtain a refined first pitch angle θ_{1aff}(t) considered as output angle,
a fifth step that is executed if the first condition is invalidated and that consists in considering said first pitch angle θ₁(t) such as computed in the course of the first step as output angle.

Thus, the method according to an aspect of the invention allows estimation of the pitch angle of the vehicle to be improved by estimating the pitch angle using two complementary methods and where appropriate by refining the estimated pitch angle, depending on the result of the comparison of the two methods.

According to other optional features of the method according to an aspect of the invention, which may be implemented alone or in combination:
the comparing third step consists in examining at least a second condition that is validated if the quality of the estimation of the first pitch angle θ₁(t) computed in the course of the first step, and if the quality of the estimation of the second pitch angle θ₂(t) computed in the course of the second step, are each greater than a second predefined threshold, and the fourth step is executed if the first condition and the second condition are validated, and the fifth step is executed if the first condition or the second condition are invalidated. This feature allows the refinement of the pitch angle to be made subject to a threshold in respect of quality of the first pitch angle and of the second pitch angle;
the comparing third step consists in examining a third condition that is validated if the absolute difference between the first pitch angle θ₁(t) and a calibration angle θ_{calib}(t) at the current time t is less than the absolute difference between the second pitch angle θ₂(t) and said calibration angle θ_{calib}(t), or if the calibration angle θ_{calib}(t) is comprised between the first pitch angle θ₁(t) and the second pitch angle θ₂(t), the calibration angle θ_{calib}(t) being known at all times and corresponding to the nominal value of the tilt angle of the sensor when the motor vehicle is not moving, and the fourth step is executed if said conditions are all validated, and the fifth step is executed if at least one of said conditions is invalidated. This feature allows the refinement of the pitch angle to be made subject to a difference between the calibration angle and the first pitch angle and the second pitch angle;
the method comprises:
a comparing sixth step consisting in examining a fourth condition that is validated if the first pitch angle θ₁(t) is greater than the second pitch angle θ₂(t) and the refined first pitch angle θ_{1aff}(t) is less than the second pitch angle θ₂(t), or if the first pitch angle θ₁(t) is less than the second pitch angle θ₂(t) and the refined first pitch angle θ_{1aff}(t) is greater than the second pitch angle θ₂(t),
a seventh step that is executed if the fourth condition is validated and that consists in considering said second pitch angle θ₂(t) such as computed in the course of the second step as output angle,
an eighth step that is executed if the fourth condition is invalidated and that consists in considering said refined first pitch angle θ_{1aff}(t) as output angle. This feature aims to give preference to the second pitch angle obtained according to the second estimating method under certain conditions;
the first method for estimating the first pitch angle θ₁(t) of the sensor includes at least:
a first phase of computing a pitch angle of the sensor estimated by integrating the relative movement of the sensor θᵢₙₜ(t) at a current time t, using the following equation:

$${θ}_{i n t} ( t ) = {θ}_{1} ( t - 1 ) - {θ}_{rel} ( t )$$

with:
i. θ₁(t−1) the first pitch angle θ₁(t) of the sensor at a previous time t−1, and
ii. θᵣₑₗ(t) a relative angle of the sensor at the current time t that expresses the angle of the sensor between said previous time t−1 and the current time t, and
a second phase of estimating the first pitch angle θ₁(t) of the sensor, using the following equation:

$${θ}_{1} ( t ) = {θ}_{i n t} ( t ) + D A C ( t ) * ( {θ}_{calib} ( t ) - {θ}_{i n t} ( t ) )$$

i. θ₁(t) the first pitch angle of the sensor, at the current time t,
ii. θᵢₙₜ(t) the pitch angle of the sensor estimated by integrating the relative movement of the sensor in the course of the preceding computing first phase, at the current time t,
iii. DAC(t) the drift-avoidance coefficient, comprised between zero and one, at the current time t,
iv. θ_{calib}(t) a calibration angle at the current time t, which is known at all times and which corresponds to the nominal value of the tilt angle of the sensor when the motor vehicle is not moving;
the drift-avoidance coefficient DAC(t) depends partly on the acceleration of the motor vehicle and partly on the relative movement of the sensor between the current time t and a previous time, the estimating second phase comprising computing the drift-avoidance coefficient DAC(t) using the following equation:

$$D A C ( t ) = min ( min ( D A {C}_{rel} ( t ) , D A {C}_{\vec{a}} ( t ) ) )$$

with:
DACᵣₑₗ(t) a relative drift-avoidance coefficient that depends on the movement of the sensor and that is obtained using the following equation:

$$D A {C}_{rel} ( t ) = D A {C}_{Ma xRel} * ( 1 - min ( {\int }_{t - NRel}^{t} \frac{\vert {θ}_{rel} ( x ) \vert}{θ A M R} dx , 1 ) )$$

with DAC_{MaxRel} a redetermined maximum value of the relative drift-avoidance coefficient DACᵣₑₗ(t), Nrel a predetermined number corresponding to the selected value of the number of previous times used to determine the relative drift-avoidance coefficient DACᵣₑₗ(t), θᵣₑₗ(t) the relative angle of the sensor at the current time t, and θAMR a predetermined empirical maximum value of the relative angle of the sensor at the current time t θᵣₑₗ(t), and
DAC_{\vec{a}}(t) an acceleration drift-avoidance coefficient that depends on the acceleration of the motor vehicle (10), and that is obtained using the following equation:

$$D A {C}_{\vec{a}} ( t ) = D A {C}_{ma x \vec{a}} * ( 1 - min ( {\int }_{t - Na}^{t} \frac{\vert \vec{a} ( x ) \vert}{\vec{a} A M R} dx , 1 ) )$$

with DAC_{max\vec{a}} a predetermined maximum value of the acceleration drift-avoidance coefficient DAC_{\vec{a}}(t), Na the predetermined number corresponding to the selected value of the number of previous times used to determine the acceleration drift-avoidance coefficient DAC_{\vec{a}}(t), \vec{a}(t) the acceleration of the motor vehicle at the time t, and \vec{a}AMR a predetermined empirical maximum value of the acceleration \vec{a}(t) of the motor vehicle,
and, in the course of the fourth step, the drift-avoidance coefficient DAC(t) is increased by increasing the predetermined maximum value DAC_{MaxRel} of the relative drift-avoidance coefficient DACᵣₑₗ(t) and by increasing the predetermined maximum value DAC_{max\vec{a}} of the acceleration drift-avoidance coefficient DAC_{\vec{a}}(t);
a penalty drift-avoidance coefficient DACₚₑₙ(t) is added to the drift-avoidance coefficient DAC(t) when the measured longitudinal acceleration of the motor vehicle is inconsistent with the variation in the first pitch angle θ₁(t) of the sensor;
the penalty drift-avoidance coefficient DACₚₑₙ(t) is obtained using the following equation:
   DACₚₑₙ(t)=max(DAC_{MaxPen}(\vec{a}(t)*θᵢₙₜ(t)), 0) with DAC_{MaxPen} a predetermined maximum value of the penalty drift-avoidance coefficient DACₚₑₙ(t), \vec{a}(t) the longitudinal acceleration of the motor vehicle and θᵢₙₜ(t) the pitch angle of the sensor estimated by integrating the relative movement of the sensor at a current time t;
the drift-avoidance coefficient DAC(t) is obtained using the following equation:
   DAC(t)=min(min(DACᵣₑₗ(t),DAC_{\vec{a}}(t))+DACₚₑₙ(t),1) with DACᵣₑₗ(t) the relative drift-avoidance coefficient that depends on the movement of the sensor, DAC_{\vec{a}}(t) the acceleration drift-avoidance coefficient and DACₚₑₙ(t) the penalty drift-avoidance coefficient;
the quality of the estimation of the first pitch angle θ₁(t) depends on the quality of the relative angle θᵣₑₗ(t) and on the quality of the calibration angle θ_{calib}(t);
the second method for estimating the second pitch angle θ₂(t) of the sensor consists in processing the images acquired by the sensor with a view to recognizing therein, in each image, the shape of line markings of the road over which the motor vehicle is being driven and to deducing therefrom the estimation of the second pitch angle θ₂(t);
the second method for estimating the second pitch angle θ₂(t) of the sensor consists in:
analyzing at least one image acquired by the sensor at a time t with a view to recognizing line markings of the road in said image, and selecting a plurality of points belonging to the line markings,
defining a vanishing point where said line markings cross, and
comparing the position of said vanishing point with the position of the optical center of the sensor with a view to estimating the second pitch angle θ₂(t) of the sensor;
the quality of the estimation of the second pitch angle θ₂(t) depends on the number of selected points belonging to the line markings and on the length of said line markings visible in the acquired image;
the first pitch angle θ₁(t) of the sensor is a pitch angle that corresponds to an angular movement of the sensor about a transverse axis that on the whole is perpendicular to the longitudinal path of the motor vehicle.

An aspect of the present invention also relates to a device for dynamically estimating the pitch of a motor vehicle by means of at least one image-acquiring sensor that is located on board said motor vehicle, said device being intended to implement the method according to any one of the above features, said device comprising at least one image-acquiring sensor that is mounted on said vehicle and a processing unit for determining the first pitch angle θ₁(t) and the second pitch angle θ₂(t) of the sensor.

### BRIEF DESCRIPTION OF THE DRAWINGS

Other features and advantages of aspects of the invention will become apparent on reading the following description, with reference to the appended figures, which illustrate:

FIG. 1 is a schematic view of a motor vehicle equipped with a suspended cab and a video camera;

FIG. 2 is a flowchart of the steps of the method for dynamically estimating the pitch of the motor vehicle according to an aspect of the invention;

FIG. 3 is a schematic view of the motor vehicle of FIG. 1, in which the camera has a first video-camera pitch angle according to a first estimating method;

FIG. 4 is an example of variation in the orientation of the camera relative to the pitch angle;

FIG. 5 is a schematic view of an image captured by the camera showing road line markings;

FIG. 6 is a schematic view similar to the one in FIG. 3 showing the first video-camera pitch angle according to a first estimating method and the second video-camera pitch angle according to a second estimating method.

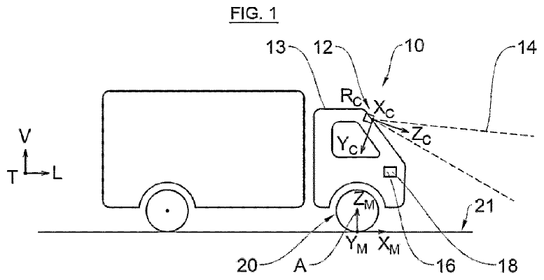

In the exhibits of the present application, non-limitingly and with reference to the system of axes L, V, T indicated in FIGS. 1 and 3 to 6, the terminology longitudinal, vertical and transverse will be employed, the motor vehicle being considered to extend longitudinally and to move forward longitudinally.

In all these figures, identical or similar elements have been designated by identical or similar reference signs in all the figures.

### DETAILED DESCRIPTION OF THE PREFERRED EMBODIMENTS

FIG. 1 shows a motor vehicle 10 of the truck type, on board of which is located an image-acquiring sensor that consists of a video camera 12.

The video camera 12 is mounted on the front windshield of a driver's cab 13, for example in the vicinity of the central rear-view mirror, so as to scrutinize the immediate environment of the motor vehicle 10, as illustrated in FIG. 1 by the field of view 14 of the video camera 12.

The digital images acquired by the video camera 12 are transmitted to a processing unit 16 belonging to an advanced driver assistance system, for example in order to allow the advanced driver assistance system to detect objects and to make a decision to actively intervene in driving the motor vehicle 10.

Also, the advanced driver assistance system comprises a device 18 for dynamically estimating the pitch of the motor vehicle 10, which is configured to implement a method for dynamically estimating the pitch of the motor vehicle 10 by means of the video camera 12, according to an aspect of the invention.

By pitch what is meant is an absolute extrinsic tilt angle of the video camera 12 corresponding to an angular oscillating movement of the video camera 12 about a transverse axis A that on the whole is perpendicular to the longitudinal path of the motor vehicle 10, as may be seen in FIG. 1.

FIG. 1 shows a first three-dimensional frame R_{C}{x_{C}, y_{C}, z_{C}} that is called the camera frame and that is linked to the video camera 12, and a second three-dimensional frame R_{M} {x_{M}, y_{M}, z_{M}} that is called the world frame. The world frame R_{M} is linked to the front wheel set 20 of the motor vehicle 10 and is projected onto the road.

Generally, by pitch angle what is meant is an angle of rotation between axes of the camera frame R_{C} and axes of the world frame R_{M}.

It will be noted that under certain conditions, in particular in the event of passage over a humpback bridge, the pitch angle is an angle of rotation between axes of the camera frame R_{C} and axes of a gravitational frame (not shown) i.e. a frame that has a vertical axis aligned with the direction of earth's gravity.

Those skilled in the art will understand that the pitch shown here, and the estimation of which is an aspect of the invention, is the extrinsic pitch, in the sense defined above with reference more generally to the extrinsic parameters of the video camera 12.

The potential variation in the intrinsic parameters, such as defined above, is not the object of the estimation described below. Specifically, these parameters are calibrated and, in general, are not subject to significant variations over short time scales. They may therefore be considered stable with regard to the dynamic phenomena which the estimating method according to an aspect of the invention aims to follow, which are related to events that happen while driving, such as passing over a humpback bridge or over a speed bump, i.e. over an abrupt bump or dip in the case of pitch.

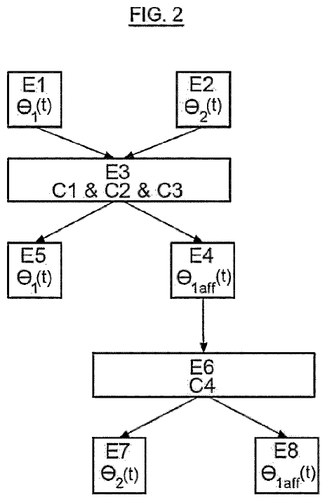

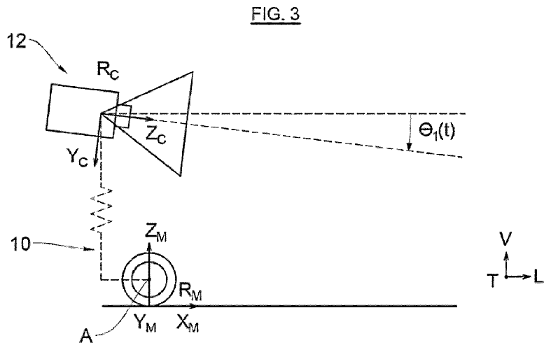

With reference to FIG. 2, according to a first embodiment of the method for dynamically estimating the pitch of the motor vehicle 10 by means of the video camera 12 according to the invention, the method comprises a first estimating step E1, which consists in estimating a first absolute extrinsic pitch angle θ₁(t) of the video camera 12, as illustrated in FIG. 3, using a first estimating method.

The first method for estimating the first pitch angle θ₁(t) integrates a drift-avoidance coefficient DAC(t) that aims to limit drift of the estimation of the first pitch angle θ₁(t).

More particularly, the first method for estimating the first pitch angle θ₁(t) of the video camera 12 comprises a first phase of computing an extrinsic pitch angle of the video camera 12, which angle is estimated by integrating the relative movement of the camera θᵢₙₜ(t) at a current time t, using the following equation:

$${θ}_{i n t} ( t ) = {θ}_{1} ( t - 1 ) - {θ}_{rel} ( t )$$

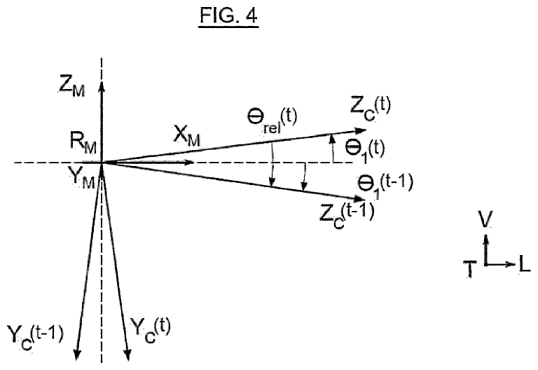

with, as may be seen in FIG. 4, θ₁(t−1) the first estimated absolute extrinsic pitch angle θ₁(t) of the video camera 12 at a previous time t−1, and θᵣₑₗ(t) a relative tilt angle of the video camera 12 at the current time t, which expresses the angle of the video camera 12 between the previous time t−1 and the current time t.

By previous time, what is for example meant is the time of the previous acquisition of the image by the video camera 12 in a sequence of successive acquisitions, or the time of the acquisition of an image separated by a given number of acquisitions, which number is for example chosen in advance, in said sequence, or else the time of acquisition of a prior image acquired a certain time before the time t.

Likewise, the expression “relative camera movement” means the movement of the camera between an image captured at a time t and another image captured at a previous time.

An example of the variation in the orientation of the video camera 12 is given in FIG. 4.

In addition, the first method for estimating the first pitch angle θ₁(t) of the video camera 12 comprises a second phase of estimating the first pitch angle θ₁(t) of the video camera 12 using the following equation:

$${θ}_{1} ( t ) = {θ}_{i n t} ( t ) + D A C ( t ) * ( {θ}_{calib} ( t ) - {θ}_{i n t} ( t ) )$$

with θ₁(t) the first pitch angle of the video camera 12 at the current time t, θᵢₙₜ(t) the pitch angle of the video camera 12 estimated by integrating the relative movement of the camera in the course of the preceding computing first phase, at the current time t, DAC(t) the drift-avoidance coefficient comprised between zero and one, at the current time t, θ_{calib}(t) an extrinsic calibration angle at the current time t, which is known at each time and which corresponds to the nominal value of the tilt angle of the video camera 12 when the motor vehicle 10 is not moving.

The value of the extrinsic calibration angle θ_{calib}(t) as a function of time may be obtained using any known extrinsic calibration method, such as the SLAM method described above.

The calibration extrinsic tilt angle θ_{calib}(t) is a reference angle, it is also possible to use the angle of the video camera 12 as set during design of the vehicle, or the angle estimated during calibration at the end of the production line of the vehicle.

The drift-avoidance coefficient DAC(t) avoids, as its name suggests, drift in the estimation of the first pitch angle θ₁(t).

Specifically, the first estimated pitch angle θ₁(t) may drift from the true value through accumulation overtime of errors in the estimation of the angle estimated by integrating the relative movement of the camera θᵢₙₜ(t).

In the absence of the drift-avoidance coefficient DAC(t), potential errors in estimating the relative tilt angle θᵣₑₗ(t) of the video camera 12 would be summed over time, which could result in errors in estimating the first estimated pitch angle θ₁(t) and, in extreme cases, significant discrepancies between the first estimated pitch angle θ₁(t) and the actual tilt angle.

Depending on the value attributed to the drift-avoidance coefficient DAC(t), computation of the tilt angle θ(t) is restricted to a greater or lesser extent by the calibration angle θ_{calib}(t)−the drift-avoidance coefficient DAC(t) is said to be conservative to a greater or lesser extent.

In order for the estimation of the first pitch angle θ₁(t) of the video camera 12 to be able to handle, without drifting, the multitude of driving scenarios that may be encountered, the drift-avoidance coefficient DAC(t) is computed, in the course of the estimating second phase of the method, using the following equation:

$$D A C ( t ) = min ( min ( D A {C}_{rel} ( t ) , D A {C}_{\vec{a}} ( t ) ) )$$

with:
DACᵣₑₗ(t) a relative drift-avoidance coefficient that depends on the movement of the video camera 12 and that is obtained using the following equation:

$$D A {C}_{rel} ( t ) = D A {C}_{M axRel} * ( 1 - min ( {\int }_{t - NRel}^{t} \frac{\vert {θ}_{rel} ( x ) \vert}{θ A M R} dx , 1 ) )$$

with DAC_{MaxRel} a predetermined maximum value of the relative drift-avoidance coefficient DACᵣₑₗ(t), NRel a predetermined number corresponding to the selected value of the number of previous times used to determine the relative drift-avoidance coefficient DACᵣₑₗ(t), θᵣₑₗ(t) the relative angle of the video camera 12 at the current time t, and θAMR a predetermined empirical maximum value of the relative angle of the video camera 12 at the current time t θᵣₑₗ(t).

The acceleration drift-avoidance coefficient DAC_{\vec{a}}(t) is a drift-avoidance coefficient that depends on the acceleration of the motor vehicle 10, and that is obtained using the following equation:

$$D A {C}_{\vec{a}} ( t ) = D A {C}_{m ax \vec{a}} * ( 1 - min ( {\int }_{t - Na}^{t} \frac{\vert \vec{a} ( x ) \vert}{\vec{a} A M R} dx , 1 ) )$$

with DAC_{max\vec{a}} a predetermined maximum value of the acceleration drift-avoidance coefficient DAC_{\vec{a}}(t), Na the predetermined number corresponding to the selected value of the number of previous times used to determine the acceleration drift-avoidance coefficient DAC_{\vec{a}}(t), \vec{a}(t) the acceleration of the motor vehicle 10 at the time t, and θAMR a predetermined empirical maximum value of the acceleration \vec{a}(t) of the motor vehicle 10.

It will be noted that the parameters DAC_{MaxRel}, Nrel, θAMR, DAC_{max\vec{a}}, Na and \vec{a}AMR may be modified to adjust the behavior of the algorithm allowing the first pitch angle θ₁(t) of the video camera 12 to be estimated.

Advantageously, the drift-avoidance coefficient DAC(t) depends both on the movement of the video camera 12 between the current time t and a previous time t−1 with the relative drift-avoidance coefficient DACᵣₑₗ(t), and also on the acceleration of the motor vehicle 10 with the acceleration drift-avoidance coefficient DAC_{\vec{a}}(t).

Specifically, when the inter-image movement is large, during passage over a pothole or a speed cushion for example, the relative drift-avoidance coefficient DACᵣₑₗ(t) tends toward zero and the first estimated pitch angle θ₁(t) of the video camera 12 approaches the angle of the video camera 12 estimated by integrating the relative motion of the camera θᵢₙₜ(t).

In contrast, when the inter-image movement is small, for example in the course of a long period of emergency braking or when crossing a roundabout, the relative drift-avoidance coefficient DACᵣₑₗ(t) tends toward the predetermined maximum value DACₘₐₓᵣₑₗ of the acceleration drift-avoidance coefficient DAC_{\vec{a}}(t) and the estimation of the first pitch angle θ₁(t) approaches its reference value, which is the calibration angle θ_{calib}(t) in the example described here.

The acceleration drift-avoidance coefficient DAC_{\vec{a}}(t) does not depend on the movement of the video camera 12 but on the acceleration \vec{a}(t) of the motor vehicle 10.

It will be noted that the acceleration \vec{a}(t) of the motor vehicle 10 is a longitudinal acceleration along the longitudinal path of the motor vehicle 10.

Making the acceleration drift-avoidance coefficient DAC_{\vec{a}}(t) depend on the acceleration \vec{a}(t) makes it possible to take into consideration scenarios in which the cab of the motor vehicle 10, or more generally the holder of the video camera 12, is tilted for a non-negligible time by an inertial force.

According to one embodiment variant of the first embodiment of the method according to the invention, a penalty drift-avoidance coefficient DACₚₑₙ(t) is added to the drift-avoidance coefficient DAC(t) so that:

$$D A C ( t ) = min ( min ( D A {C}_{rel} ( t ) , D A {C}_{\vec{a}} ( t ) ) + D A {C}_{pen} ( t ) , 1 )$$

with DACᵣₑₗ(t) the relative drift-avoidance coefficient that depends on the movement of the video camera 12, DAC_{\vec{a}}(t) the acceleration drift-avoidance coefficient and DACₚₑₙ(t) the penalty drift-avoidance coefficient.

The penalty drift-avoidance coefficient DACₚₑₙ(t) is added to the drift-avoidance coefficient DAC(t) when the measured longitudinal acceleration of the motor vehicle 10 is inconsistent with the variation in the first pitch angle θ₁(t).

Specifically, the penalty drift-avoidance coefficient DACₚₑₙ(t) is obtained using the following equation:

$$D A {C}_{pen} ( t ) = max ( D A {C}_{Ma xPen} ( \vec{a} ( t ) * {θ}_{i n t} ( t ) ) , 0 )$$

with DAC_{MaxPen} a predetermined maximum value of the penalty drift-avoidance coefficient DACₚₑₙ(t), \vec{a}(t) the longitudinal acceleration of the motor vehicle 10 and θᵢₙₜ(t) the pitch angle of the video camera 12 estimated by integrating the relative camera movement described above.

Thus, if the longitudinal acceleration \vec{a}(t) is negative, which characterizes braking of the motor vehicle 10, and if the pitch angle estimated by integrating the relative movement of the camera θᵢₙₜ(t) is positive, which corresponds to a forward pitch, then the product \vec{a}(t)*θᵢₙₜ(t) is negative, and the measured acceleration of the motor vehicle 10 is considered consistent with the variation in the first pitch angle θ₁(t), and the penalty drift-avoidance coefficient DACₚₑₙ(t) is set to zero and therefore has no effect.

Specifically, when the motor vehicle 10 brakes, the vehicle is meant to pitch forward.

Conversely, if the product \vec{a}(t)*θᵢₙₜ(t) is positive, then the measured acceleration of the motor vehicle 10 is considered inconsistent with the variation in the first pitch angle θ₁(t), and the penalty drift-avoidance coefficient DACₚₑₙ(t) is taken into account and it will then act in such a way as to bring the value of the first pitch angle θ₁(t) back to the value of the extrinsic calibration angle θ_{calib}(t).

It will be noted that the penalty drift-avoidance coefficient DACₚₑₙ(t) is saturated with the maximum value DAC_{MaxPen} to maintain consistent behavior.

The method according to an aspect of the invention comprises a second estimating step E2, which may be executed before, after or during the first estimating step E1, and which consists in estimating a second pitch angle θ₂(t) of the video camera 12, using a second estimating method.

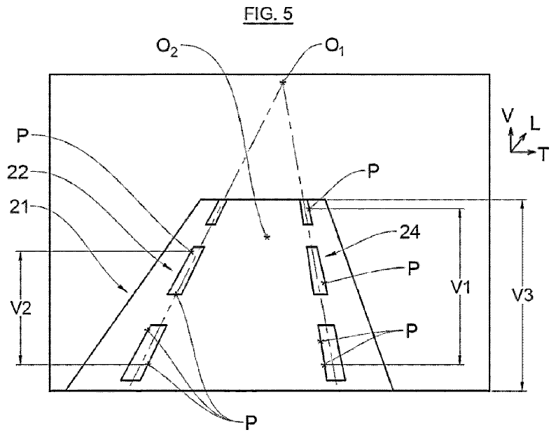

The second method for estimating the second pitch angle θ₂(t) of the video camera 12 consists in processing the images acquired by the video camera 12 with a view to recognizing therein, in each image, the shape of the line markings of the road 21 over which the motor vehicle 10 is being driven, typically a left line marking 22 and a right line marking 24 as illustrated in FIG. 5, and to deducing therefrom, in real time, a pitch angle of the video camera 12.

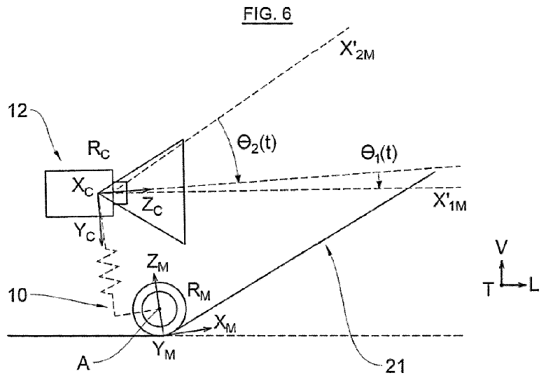

FIG. 6 shows the first pitch angle θ₁(t) obtained using the first estimating method and the second pitch angle θ₂(t) obtained using the second estimating method, when the motor vehicle 10, which has been represented by a wheel in the illustration, has just reached the base of the slope in the road 21.

It will be noted that in this configuration, the second pitch angle θ₂(t) allows the pitch between the video camera 12 and the sloping road 21 visible to the camera 12 to be estimated, rather than the pitch between the video camera 12 and the road 21 assumed to be flat, as estimated by the first pitch angle θ₁(t) obtained using the first estimating method.

Specifically, with reference to FIG. 6, the first pitch angle θ₁(t) is defined between the axis Z_{C} of the camera 12 and a fictitious axis X′_{1M} which is on the whole parallel to the length of road located before the slope, and the second pitch angle θ₂(t) is defined between the axis Zo of the camera 12 and a fictitious axis X′_{2M} that is on the whole parallel to the slope visible to the camera 12.

This type of method, based on recognition of road line markings, is known to those skilled in the art. Consequently, this method will only be briefly described below by means of one example of implementation.

Thus, the second method for estimating the second pitch angle θ₂(t) of the video camera 12 consists in analyzing at least one image acquired by the video camera 12 at a time t, in order to recognize and extract the line markings 22, 24 of the road 21 in said image, and to select a plurality of points P belonging to the line markings 22, 24 extracted beforehand.

It is assumed that the line markings 22, 24 have been extracted upstream of the first step E1 of the method according to an aspect of the invention.

By way of example, the line markings 22, 24 may be extracted using a deep convolutional neural network. These line markings 22, 24 thus detected in the image are then sampled in order to be represented as points P belonging to the extracted line markings 22, 24.

Once the line markings 22, 24 have been recognized, a vanishing point O1 is defined at the intersection of the line markings 22, 24, and the position of the vanishing point O1 is compared with the position of the optical center O2 of the video camera 12 in order to estimate the second pitch angle θ₂(t) of the video camera 12.

The second pitch angle θ₂(t) of the video camera 12 is then expressed as the arc-tangent of the difference in vertical position between the vanishing point O1 estimated from the intersection of the two extracted line markings 22, 24 and the vertical position of the optical center O2 of the video camera 12.

By way of non-limiting example, the second method for estimating the second pitch angle θ₂(t) of the video camera 12 described here, based on recognition of the line markings 22, 24, may be replaced by any other method that is suitable for estimating a pitch angle of the video camera 12 and that is complementary to the first method described above.

Still according to the first embodiment of the method according to the invention, the method comprises a comparing third step E3 (illustrated in FIG. 2) consisting in examining a first condition C1 that is validated if the absolute difference between the first pitch angle θ₁(t) and the second pitch angle θ₂(t) is greater than or equal to a first predefined threshold.

If the first condition C1 is validated, or in other words if the first condition is met, then a fourth step E4 is executed.

In contrast, if the first condition C1 is invalidated, or in other words if the first condition is not met, then a fifth step E5 is executed instead of the fourth step E4.

The fourth step E4 consists in refining the first pitch angle θ₁(t) by increasing the drift-avoidance coefficient DAC(t) to obtain a refined first pitch angle θ_{1aff}(t) considered as output angle.

By “output angle”, what is meant is the estimated pitch angle of the video camera 12 that is returned by the method according to an aspect of the invention.

To this end, in the course of the fourth step E4, the drift-avoidance coefficient DAC(t) is increased by increasing the predetermined maximum value DAC_{MaxRel} of the relative drift-avoidance coefficient DACᵣₑₗ(t) and by increasing the predetermined maximum value DAC_{max\vec{a}} of the acceleration drift-avoidance coefficient DAC_{\vec{a}}(t).

The fifth step E5 consists in considering the first pitch angle θ₁(t), such as computed in the course of the first step E1, as output angle.

Thus, according to an aspect of the present invention, the first pitch angle θ₁(t) estimated by the first method based on the relative pitch of the video camera 12 is refined with more conservative parameterization, in the case where the first pitch angle θ₁(t) is considered too far from the second pitch angle θ₂(t) estimated by the second method based on the line markings 22, 24, which proves to be more reliable in the event of a change in the slope of the road 21 in particular.

According to a second embodiment of the method according to the invention, the comparing third step E3 consists in examining a second condition C2 that is validated if the quality of the estimation of the first pitch angle θ₁(t) computed in the course of the first estimating step E1, and if the quality of the estimation of the second pitch angle θ₂(t) computed in the course of the second estimating step E2, are each greater than a second predefined threshold.

If the second condition C2 and the first condition C1 are validated, or in other words if both conditions C1, C2 are met, then the fourth step E4 described above is executed.

In contrast, if one of the first condition C1 and the second condition C2 is not met, then the fifth step E5 described above is executed instead of the fourth step E4.

According to one preferred embodiment of the invention, the quality of the estimation of the first pitch angle θ₁(t) depends on the quality of the relative angle θᵣₑₗ(t) and on the quality of the calibration angle θ_{calib}(t).

More particularly, the quality of the estimation of the first pitch angle θ₁(t) comprises a first phase of computing the quality of the angle of the video camera 12 estimated by integrating the relative motion of the camera θᵢₙₜ(t) using the following equation:

$$Quality {θ}_{i n t} ( t ) = 0.5 * Quality {θ}_{1} ( t - 1 ) + 0.5 * Quality {θ}_{rel} ( t )$$

with Qualityθ₁(t−1) the quality of the first pitch angle θ₁(t) of the video camera 12 at a previous time t−1, computed in a previous cycle, and Qualityθᵣₑₗ(t) the quality of the relative angle θᵣₑₗ(t) of the video camera 12 at the current time t.

The quality of the relative angle θᵣₑₗ(t)) is obtained using the following equation:

$${Quality θ}_{rel} ( t ) = min ( {Quality θ}_{rel} 1 ( t ) ; {Quality θ}_{r e l} 2 ( t ) )$$

$$with$$

$${Quality θ}_{rel} 1 ( t ) = 0.8 * SampsonQuality + 0.2 * ImageQuality$$

Sampson quality may be obtained using the following equation:

$$SampsonQuality = \frac{MaxSampsonDistance - ActualSampsonDistance}{MaxSampsonDistance - MinSampsonDistance}$$

with MaxSampsonDistance a set value that defines the maximum Sampson value, MinSampsonDistance a set value that defines the minimum Sampson value, and ActualSampsonDistance the Sampson distance computed on the basis of the model selected to deliver the output angle.

The image quality may be obtained using the following equation:

$$ImageQuality = \frac{NumberOfMatchingSegments}{NumberOfSegments}$$

with NumberOfSegments the number of segments formed between a point identified in a first image at a previous time t−1 and the same point identified in a second image at a following time t, the images being captured by the video camera 12, and NumberOfMatchingSegments the number of segments that are consistent with one another and that are judged to faithfully convey the movement of the video camera 12, unlike discordant segments judged to be inconsistent.

Thus, the term Qualityθᵣₑₗ2(t) corresponds to the normalized distribution quality to be comparable to the term Qualityθᵣₑₗ1(t).

To compute the distribution quality, the current image is divided into equal parts, for example twenty equal parts, and then the number of segments in each part is counted. The number of segments required for a uniform distribution of segments is computed by way of the following ratio:

$$\frac{NumberOfSegments}{NumberOfParts} .$$

Next, the normalized error with respect to a uniform distribution is computed for each part using the following equation:

$$error = \frac{\frac{NumberOfSegments}{NumberOfParts} - NumberOfSegmentsInEachPart}{\frac{NumberOfSegments}{NumberOfParts}}$$

The distribution quality is the average of the errors for all parts of the image, such that:

$$DistributionQuality = \sum \frac{1 - NumberOfErrors}{NumberOfParts}$$

Based on the above computations, the quality of the estimation of the first pitch angle θ₁(t) may be computed with the following equation:

$$Quality {θ}_{1} ( t ) = Quality {θ}_{int} ( t ) + DAC ( t ) ( Quality {θ}_{calib} ( t ) - Quality {θ}_{i n t} ( t ) )$$

with the drift-avoidance coefficient DAC(t) such as defined above.

The quality of the estimation of the second pitch angle θ₂(t), which it will be recalled is an estimation based on analysis of the road line markings 22, 24, depends on the number of selected points P belonging to the line markings 22, 24 and on the length of the line markings 22, 24, for example.

More particularly, the quality of the estimation of the second pitch angle θ₂(t) may be computed using the following equation:

$$Quality {θ}_{2} ( t ) = 0.5 ⋆ PointedNumberQuality + 0.5 ⋆ LineLengthQuality$$

with

$$PointNumberQuality = min ( 1 ; \frac{NbrPoints}{MiniNbrPoints} )$$

with MiniNbrPoints the number of points P used for the approximation of the line markings 22, 24 (for example three points P for the left line marking 22 and four points P for the right line marking in the example shown in FIG. 5) and MiniNbrPoints the minimum number of points P required to approximate the line markings 22, 24, which is a predefined number.

In addition, the quality of length of the line markings 22, 24 may be determined using the following equation:

$$LineLengthQuality = \frac{RLineLengthQuality + LLineLengthQuality}{2}$$

with RLineLengthQuality the quality of the length of the right line 24, which is equal to:

$$\frac{VerticalSizeOfTheRightLine}{VerticalSizeOfTheRegionOfInterestOfTheImage}$$

and LLineLengthQuality the quality of the length of the left line 22, which is equal to:

$$\frac{VerticalSizeOfTheLeftLine}{VerticalSizeOfTheRegionOfInterestOfTheImage} .$$

The vertical size V1 of the right line 24, the vertical size V2 of the left line 22 and the vertical size V3 of the region of interest of the image are illustrated in FIG. 5.

Thus, the second embodiment of the method according to the invention permits execution of the fourth step E4 provided that the quality of the estimation of the first pitch angle θ₁(t) and the quality of the estimation of the second pitch angle θ₂(t) are judged sufficient. It will be recalled that the fourth step E4 aims to refine the output pitch angle by increasing the drift-avoidance coefficient DAC(t).

According to a third embodiment of the method according to the invention, the comparing third step E3 consists in examining a third condition C3 that is validated if the absolute difference between the first pitch angle θ₁(t) and the calibration angle θ_{calib}(t) at the current time t is less than the absolute difference between the second pitch angle θ₂(t) and the calibration angle θ_{calib}(t), or if the calibration angle θ_{calib}(t) is comprised between the first pitch angle θ₁(t) and the second pitch angle θ₂(t). The calibration angle θ_{calib}(t) is the one described and used above in the first method for estimating the first pitch angle θ₁(t) of the video camera 12.

If the three conditions C1, C2, C3 are met, then the fourth step E4 described above is executed.

In contrast, if one of the three conditions C1, C2, C3 is not met, then the fifth step E5 described above is executed instead of the fourth step E4.

Advantageously, the third embodiment of the invention allows an output pitch angle to be delivered that is comprised in the interval of the first pitch angle θ₁(t) and of the second pitch angle θ₂(t).

In other words, the third embodiment of the invention makes it possible not to be too conservative in respect of the calibration angle θ_{calib}(t).

According to a fourth embodiment of the method according to the invention, the method comprises a comparing sixth step E6 that is executed if the fourth step E4 is executed, as may be seen in the flowchart in FIG. 2.

The sixth step E6 consists in examining a fourth condition C4 that is validated if the first pitch angle θ₁(t) is greater than the second pitch angle θ₂(t) and if the refined first pitch angle θ_{1aff}(t) is less than the second pitch angle θ₂(t), or if the first pitch angle θ₁(t) is less than the second pitch angle θ₂(t) and if the refined first pitch angle θ_{1aff}(t) is greater than the second pitch angle θ₂(t).

If the fourth condition C4 is met, then a seventh step E7 is executed.

In contrast, if the fourth condition is not met, then an eighth step E8 is executed, instead of the seventh step E7.

The seventh step E7 consists in considering said second pitch angle θ₂(t), such as computed in the course of the second estimating step E2, as output angle.

The eighth step E8 consists in considering the refined first pitch angle θ_{1aff}(t) as output angle.

Advantageously, the fourth embodiment of the invention makes it possible neither to be too conservative, nor too liberal, in respect of the calibration angle θ_{calib}(t).

Advantageously, the method according to an aspect of the invention allows the pitch angle of the vehicle to be estimated in a stable manner in phases of small pitch wise movement of the video camera 12.

Also, the method according to an aspect of the invention is reactive in phases of large pitchwise movement of the video camera 12, and in particular in a phase of changing slope.

In addition, the pitch angle estimated by means of the method according to an aspect of the invention rapidly returns to a value relative to the road, and not to the start point of the integration, after a long length of inclined road.

Naturally, an aspect of the invention is described above by way of example. It should be understood that those skilled in the art will be able to produce various variant embodiments of the invention without thereby departing from the scope of the invention.

For example, the various embodiments of the invention may be combined with one another.

1. A method for estimating the pitch of a motor vehicle by at least one image-acquiring sensor that is located on board said motor vehicle and that is able to deliver images of the road over which the motor vehicle is moving, the method comprising at least:
a first estimating step consisting in estimating a first pitch angle θ₁(t) of the sensor using a first estimating method that integrates a drift-avoidance coefficient DAC(t) aiming to limit drift of the estimation of the first pitch angle θ₁(t),
a second estimating step that consists in estimating a second pitch angle θ₂(t) of the sensor, using a second estimating method,
a comparing third step consisting in examining at least a first condition that is validated if the absolute difference between the first pitch angle θ₁(t) and the second pitch angle θ₂(t) is greater than or equal to a first predefined threshold,
a fourth step that is executed if a criterion is met, the criterion comprising at least validation of the first condition, and that consists in refining said first pitch angle θ₁(t) by increasing the drift-avoidance coefficient DAC(t) to obtain a refined first pitch angle θ_{1aff}(t) considered as output angle, and
a fifth step that is executed if the first condition is invalidated and that consists in considering said first pitch angle θ₁(t) such as computed in the course of the first step as output angle.

2. The method as claimed in claim 1, wherein the comparing third step consists in examining at least a second condition that is validated if the quality of the estimation of the first pitch angle θ₁(t) computed in the course of the first step, and if the quality of the estimation of the second pitch angle θ₂(t) computed in the course of the second step, are each greater than a second predefined threshold, and in that the fourth step is executed if a criterion is met, the criterion further comprising validation of the second condition, and in that the fifth step is executed if the first condition or the second condition are invalidated.

3. The method as claimed in claim 2, wherein the comparing third step consists in examining a third condition that is validated if the absolute difference between the first pitch angle θ₁(t) and a calibration angle θ_{calib}(t) at the current time t is less than the absolute difference between the second pitch angle θ₂(t) and said calibration angle θ_{calib}(t), or if the calibration angle θ_{calib}(t) is comprised between the first pitch angle θ₁(t) and the second pitch angle θ₁(t), the calibration angle θ_{calib}(t) being known at all times and corresponding to the nominal value of the tilt angle of the sensor when the motor vehicle is not moving, and in that the fourth step is executed if a criterion is met, the criterion further comprising validation of the third condition, and in that the fifth step is executed if at least one of said conditions is invalidated.

4. The method as claimed in claim 1, further comprising:
a comparing sixth step consisting in examining a fourth condition that is validated if the first pitch angle θ₁(t) is greater than the second pitch angle θ₂(t) and the refined first pitch angle θ_{1aff}(t) is less than the second pitch angle θ₂(t), or if the first pitch angle θ₁(t) is less than the second pitch angle θ₂(t) and the refined first pitch angle θ_{1aff}(t) is greater than the second pitch angle θ₂(t),
a seventh step that is executed if the fourth condition is validated and that consists in considering said second pitch angle θ₂(t) such as computed in the course of the second step as output angle, and
an eighth step that is executed if the fourth condition is invalidated and that consists in considering said refined first pitch angle θ_{1aff}(t) as output angle.

5. The method as claimed in claim 1, wherein the first method for estimating the first pitch angle θ₁(t) of the sensor comprises at least:
a first phase of computing a pitch angle of the sensor estimated by integrating the relative movement of the sensor (12) θᵢₙₜ(t) at a current time t, using the following equation:
$${θ}_{int} ( t ) = {θ}_{1} ( t - 1 ) - {θ}_{rel} ( t )$$
with:
i. θ₁(t−1) the first pitch angle θ₁(t) of the sensor at a previous time t−1, and
ii. θᵣₑₗ(t) a relative angle of the sensor at the current time t that expresses the angle of the sensor between said previous time t−1 and the current time t, and
a second phase of estimating the first pitch angle θ₁(t) of the sensor, using the following equation:
$${θ}_{1} ( t ) = {θ}_{int} ( t ) + DAC ( t ) * ( {θ}_{calib} ( t ) - {θ}_{int} ( t ) )$$
with:
i. θ₁(t) the first pitch angle of the sensor, at the current time t,
ii. θᵢₙₜ(t) the pitch angle of the sensor estimated by integrating the relative movement of the sensor in the course of the preceding computing first phase, at the current time t,
iii. DAC(t) the drift-avoidance coefficient, comprised between zero and one, at the current time t, and
iv. θ_{calib}(t) a calibration angle at the current time t, which is known at all times and which corresponds to the nominal value of the tilt angle of the sensor when the motor vehicle is not moving.

6. The method as claimed in claim 1, wherein the drift-avoidance coefficient DAC(t) depends partly on the acceleration of the motor vehicle and partly on the relative movement of the sensor between the current time t and a previous time, the estimating second phase comprising computing the drift-avoidance coefficient DAC(t) using the following equation:
$$DAC ( t ) = min ( min ( {DAC}_{rel} ( t ) , {DAC}_{\vec{a}} ( t ) ) )$$
with:
DACᵣₑₗ(t) a relative drift-avoidance coefficient that depends on the movement of the sensor and that is obtained using the following equation:
$${DAC}_{r e l} ( t ) = {DAC}_{MaxRel} * ( 1 - min ( {\int }_{t - NRel}^{t} \frac{\vert {θ}_{rel} ( x ) \vert}{θ AMR} dx , 1 ) )$$
with DAC_{MaxRel} a predetermined maximum value of the relative drift-avoidance coefficient DACᵣₑₗ(t), Nrel a predetermined number corresponding to the selected value of the number of previous times used to determine the relative drift-avoidance coefficient DACᵣₑₗ(t), θᵣₑₗ(t) the relative angle of the sensor at the current time t, and θAMR a predetermined empirical maximum value of the relative angle of the sensor at the current time t θᵣₑₗ(t), and
DAC_{\vec{a}}(t) an acceleration drift-avoidance coefficient that depends on the acceleration of the motor vehicle, and that is obtained using the following equation:
$${DAC}_{\vec{a}} ( t ) = {DAC}_{max \vec{a}} * ( 1 - min ( {\int }_{t - Na}^{t} \frac{\vert \vec{a} ( x ) \vert}{\vec{a} AMR} dx , 1 ) )$$
with DAC_{max\vec{a}} a predetermined maximum value of the acceleration drift-avoidance coefficient DAC_{\vec{a}}(t), Na the predetermined number corresponding to the selected value of the number of previous times used to determine the acceleration drift-avoidance coefficient DAC_{\vec{a}}(t), \vec{a}(t) the acceleration of the motor vehicle at the time t, and \vec{a}AMR a predetermined empirical maximum value of the acceleration \vec{a}(t) of the motor vehicle,
and in that, in the course of the fourth step, the drift-avoidance coefficient DAC(t) is increased by increasing the predetermined maximum value DAC_{MaxRel} of the relative drift-avoidance coefficient DACᵣₑₗ(t) and by increasing the predetermined maximum value DACₘₐₓa of the acceleration drift-avoidance coefficient DAC_{\vec{a}}(t).

7. The method as claimed in claim 1, wherein a penalty drift-avoidance coefficient DACₚₑₙ(t) is added to the drift-avoidance coefficient DAC(t) when the measured longitudinal acceleration of the motor vehicle is inconsistent with the variation in the first pitch angle θ₁(t) of the sensor.

8. The method as claimed in claim 7, wherein the penalty drift-avoidance coefficient DACₚₑₙ(t) is obtained using the following equation:
DACₚₑₙ(t)=max(DAC_{MaxPen}(\vec{a}(t)*θᵢₙₜ(t)), 0) with DAC_{MaxPen} a predetermined maximum value of the penalty drift-avoidance coefficient DACₚₑₙ(t), \vec{a}(t) the longitudinal acceleration of the motor vehicle and θᵢₙₜ(t) the pitch angle of the sensor estimated by integrating the relative movement of the sensor at a current time t.

9. The method as claimed in claim 6, wherein the drift-avoidance coefficient DAC(t) is obtained using the following equation:
DAC(t)=min(min(DACᵣₑₗ(t),DAC_{\vec{a}}(t))+DACₚₑₙ(t),1) with DACᵣₑₗ(t) the relative drift-avoidance coefficient that depends on the movement of the sensor, DAC_{\vec{a}}(t) the acceleration drift-avoidance coefficient and DACₚₑₙ(t) the penalty drift-avoidance coefficient.

10. The method as claimed in claim 5, wherein the quality of the estimation of the first pitch angle θ₁(t) depends on the quality of the relative angle θᵣₑₗ(t) and on the quality of the calibration angle θ_{calib}(t).

11. The method as claimed in claim 1, wherein the second method for estimating the second pitch angle θ₂(t) of the sensor consists in processing the images acquired by the sensor with a view to recognizing therein, in each image, the shape of line markings of the road on which the motor vehicle is being driven and to deducing therefrom the estimation of the second pitch angle θ₂(t).

12. The method as claimed in claim 11, wherein the second method for estimating the second pitch angle θ₂(t) of the sensor consists in:
analyzing at least one image acquired by the sensor at a time t with a view to recognizing line markings of the road in said image, and selecting a plurality of points belonging to the line markings,
defining a vanishing point where said line markings cross, and
comparing the position of said vanishing point with the position of the optical center of the sensor with a view to estimating the second pitch angle θ₂(t) of the sensor.

13. The method as claimed in claim 2, wherein the quality of the estimation of the second pitch angle θ₂(t) depends on the number of selected points belonging to the line markings and on the length of said line markings visible in the acquired image.

14. The method as claimed in claim 1, wherein the first pitch angle θ₁(t) of the sensor is a pitch angle that corresponds to an angular movement of the sensor about a transverse axis that on the whole is perpendicular to the longitudinal path of the motor vehicle.

15. A device for dynamically estimating the pitch of a motor vehicle by at least one image-acquiring sensor that is located on board said motor vehicle, said device being intended to implement the method according to claim 1, said device comprising at least one image-acquiring sensor that is mounted on said vehicle and a processing unit for determining the first pitch angle θ₁(t) and the second pitch angle θ₂(t) of the sensor.

16. The method as claimed in claim 12, wherein the quality of the estimation of the second pitch angle θ₂(t) depends on the number of selected points belonging to the line markings and on the length of said line markings visible in the acquired image.

17. The method as claimed in claim 7, wherein the drift-avoidance coefficient DAC(t) is obtained using the following equation:
DAC(t)=min(min(DACᵣₑₗ(t),DAC_{\vec{a}}(t))+DACₚₑₙ(t),1) with DACᵣₑₗ(t) the relative drift-avoidance coefficient that depends on the movement of the sensor (12), DAC_{\vec{a}}(t) the acceleration drift-avoidance coefficient and DACₚₑₙ(t) the penalty drift-avoidance coefficient.

18. The method as claimed in claim 8, wherein the drift-avoidance coefficient DAC(t) is obtained using the following equation:
DAC(t)=min(min(DACᵣₑₗ(t),DAC_{\vec{a}}(t))+DACₚₑₙ(t),1) with DACᵣₑₗ(t) the relative drift-avoidance coefficient that depends on the movement of the sensor, DAC_{\vec{a}}(t) the acceleration drift-avoidance coefficient and DACₚₑₙ(t) the penalty drift-avoidance coefficient.
